(19) United States
(12) Patent Application Publication
(10) Pub. No.: US 2008/0016320 A1
(43) Pub. Date: Jan. 17, 2008

(54) Vector Predicates for Sub-Word Parallel Operations

(76) Inventors: Amitabh Menon, Lewisville, TX (US); David J. Hoyle, Sugarland, TX (US)

Correspondence Address: TEXAS INSTRUMENTS INCORPORATED, P O BOX 655474, M/S 3999, DALLAS, TX, 75265, US

(21) Appl. No.: 11/769,198

(22) Filed: Jun. 27, 2007

Related U.S. Application Data
(60) Provisional application No. 60/805,904, filed on Jun. 27, 2006.

(51) Int. Cl. G06F 15/00

(52) U.S. Cl. 712/22; 712/E09.001

(57) ABSTRACT

This invention uses vector predicate registers to control conditional execution of instructions for vector elements within a data word. A particular vector predicate registers is addressed via a register index. The state of bits of the vector predicate register controls whether a corresponding sub-word operation is executed or inhibited.

### BACKGROUND OF THE INVENTION

Sub-word parallel instructions (often called SIMD instructions) implement vector computation for short vectors packed into data words. Vector computers that feature vector instructions operate on vector register files. These SIMD instructions split the scalar machine data word into smaller slices/sub-words and operate on the slices independently. This generally involves breaking the carry chain at the element boundaries. This provides low cost vector style operations on arrays if the array elements are short enough to be packed into a machine word. Iterating over the data with such SIMD instructions can yield high performance.

SIMD instructions are often a good fit to a variety of algorithms in media and signal processing. SIMD instruction extensions have been added to most general purpose microprocessor instruction sets, for example MMX, 3DNOW, SSE, VMX, Altivec and VIS. Digital signal processors (DSPs) such as the Texas Instruments C6400 family utilize SIMD instructions to exploit data parallelism when operating on short width data arrays.

There are some restrictions on the general use of such SIMD instructions on long vectors. The starting address for the arrays should be aligned to the data word width. This SIMD instruction operation works correctly only if the vector elements are similarly aligned within data words. Another problem concerns the number of elements in the two input vectors. The number of elements in the vectors n should be divisible by the SIMD width. Further, if the operation were conditional for some elements the prior art SIMD instruction cannot be used.

### SUMMARY OF THE INVENTION

This invention uses vector predicate registers to solve these problems. A vector predicate register is similar to predicate registers in that the values stored in the register are used to control conditional execution of instructions. The vector predicate registers of this invention are an aggregate of multiple predicate registers. The vector predicate register is addressed with a register index and the constituent registers are either accessed all together or addressed specifically with an index. A SIMD operation can then predicated with a vector predicate that operates on the sub-words of the operands. The value stored in each predicate element in the predicate vector controls whether a corresponding sub-word operation is executed or inhibited. No prior art use of SIMD instructions adequately deal with these problems.

### BRIEF DESCRIPTION OF THE DRAWINGS

These and other aspects of this invention are illustrated in the drawings, in which:

FIG. 1 illustrates the organization of the data processor of the preferred embodiment of this invention;

FIG. 2 illustrates a representative sub-cluster of the data processor of FIG. 1;

FIG. 3 illustrates the connectivity of a representative transport switch of the data processor of FIG. 1;

FIG. 4 illustrates the pipeline stages of the data processor illustrated in FIG. 1;

FIG. 5 illustrates a first instruction syntax of the data processor illustrated in FIG. 1;

FIG. 6 illustrates a second instruction syntax of the data processor illustrated in FIG. 1;

FIG. 7 illustrates an example of vector element processing using a SIMD instruction;

FIG. 8 illustrates an example where vector element processing using a SIMD instruction is not feasible because of memory alignment of the operand vectors;

FIG. 9 illustrates an example where vector element processing using a SIMD instruction is not feasible because of mis-alignment of the operand vectors; and

FIG. 10 illustrates an example of vector element processing using a SIMD instruction and the vector predicate of this invention.

### DETAILED DESCRIPTION OF PREFERRED EMBODIMENTS

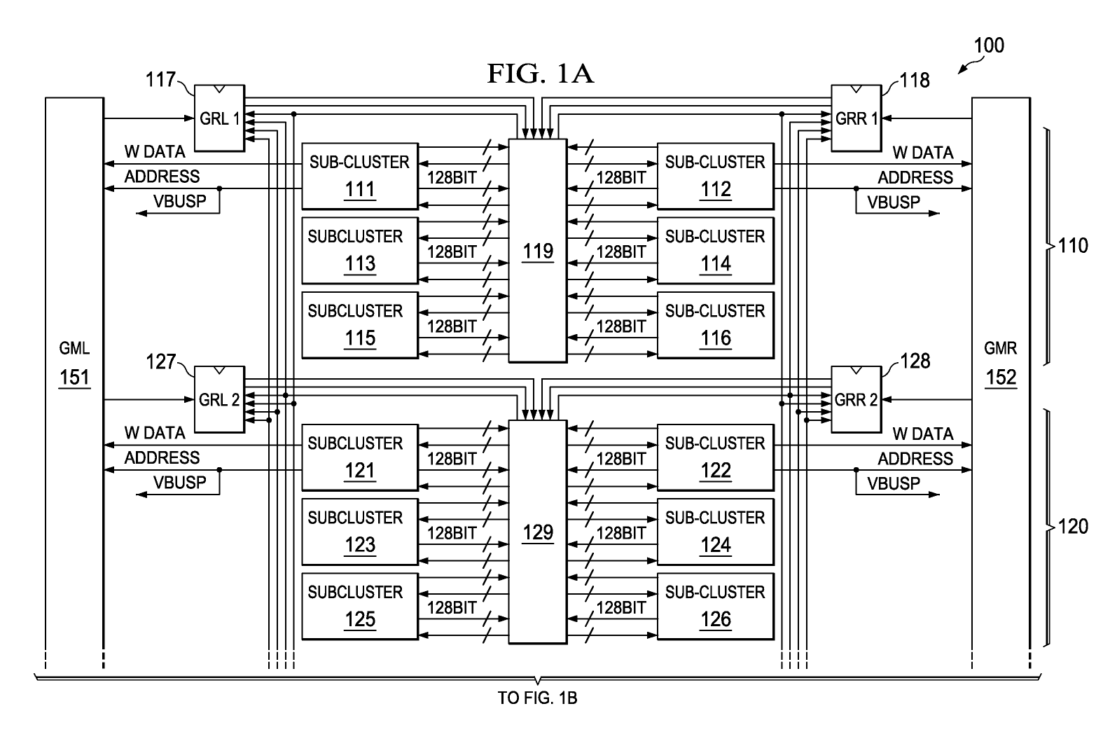

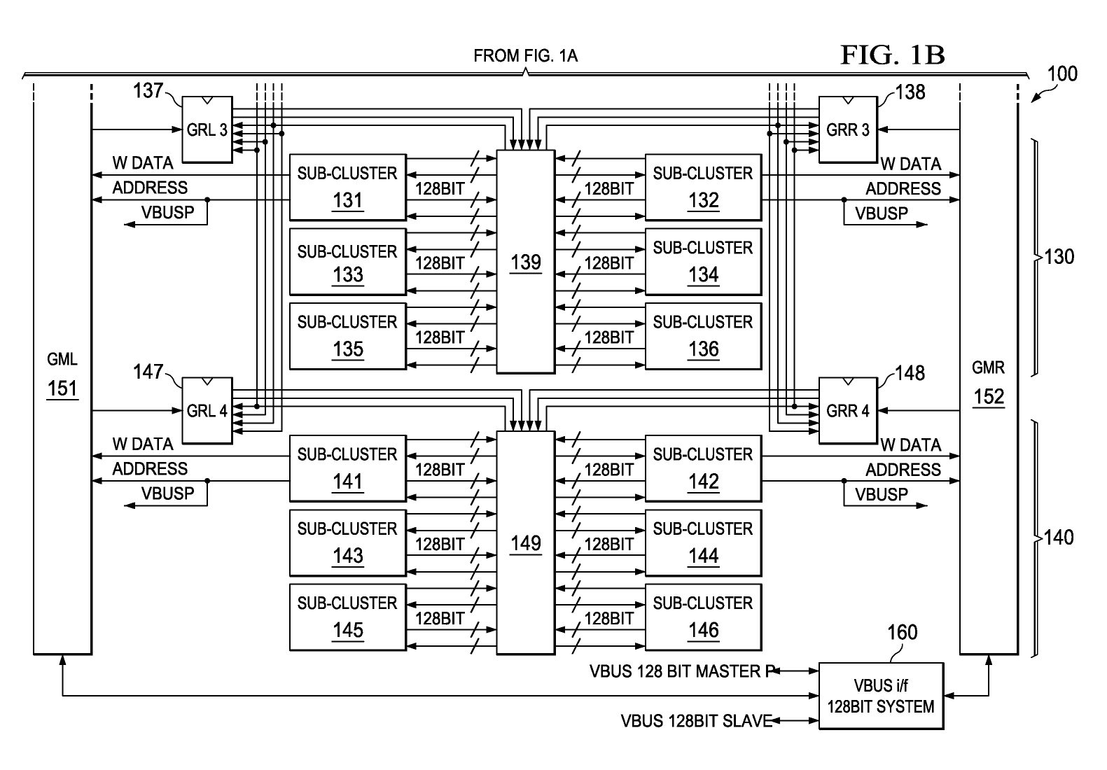

FIG. 1 illustrates a general block diagram of the data processor of this invention. Data processor 100 includes four data processing clusters 110, 120, 130 and 140. Each cluster includes six sub-clusters. Cluster 110 includes left sub-clusters 111, 113 and 115, and right sub-clusters 112, 114 and 116. The sub-clusters of cluster 110 communicate with other sub-clusters via transport switch 119. Besides connections to the sub-clusters, transport switch 119 also connects to global registers left 117 and global registers right 118. Global registers left 117 communicates with global memory left 151. Global registers right 118 communicates with global memory right 152. Global memory left 151 and global memory right 152 communicate with external devices via Vbus interface 160. Clusters 120, 130 and 140 are similarly constituted.

Each sub-cluster 111, 111, 113, 114, 115, 116, 121, 122, 123, 124, 125, 126, 131, 132, 133, 134, 135, 136, 141, 142, 143, 144, 145 and 146 includes main and secondary functional units, a local register file and a predicate register file. Sub-clusters 111, 112, 121, 122, 131, 132, 141 and 142 are called data store sub-clusters. These sub-clusters include main functional units having arithmetic logic units and memory load/store hardware directly connected to either global memory left 151 or global memory right 152. Each of these main functional units is also directly connected to Vbus interface 160. In these sub-clusters the secondary functional units are arithmetic logic units. Sub-clusters 112, 114, 122, 124, 132, 134, 142 and 144 are called math A sub-clusters. In these sub-clusters both the main and secondary functional units are arithmetic logic units. Sub-clusters 113, 116, 123, 126, 133, 136, 143 and 146 are called math M sub-clusters. The main functional units is these sub-clusters are multiply units and corresponding multiply type hardware. The secondary functional units of these sub-clusters are arithmetic logic units. Table 1 summarizes this disposition of functional units.

TABLE 1

| Sub-cluster | Main Functional | Secondary Functional |
|---|---|---|
| Type | Unit | Unit |
| Data | Load/store and ALU | ALU |
| Math A | ALU | ALU |
| Math M | Multiply | ALU |

Data processor 100 generally operates on 64-bit data words. The instruction set allows single instruction multiple data (SIMD) processing at the 64-bit level. Thus 64-bit SIMD instructions can perform 2 32-bit operations, 4 16-bit operations or 8 8-bit operations. Data processor 100 may optionally operate on 128-bit data words including corresponding SIMD instructions.

Each cluster 110, 120, 130 and 140 is separated into left and right regions. The left region is serviced by the data left sub-cluster 111, 121, 131 or 141. The right region is serviced by data right sub-cluster 112, 122, 132 or 142. These are connected to the global memory system. Any memory bank conflicts are resolved in the load/store pipeline.

Each cluster 110, 120, 130 and 140 includes its own local memory. These can be used for holding constants for filters or some kind of ongoing table such as that used in turbo decode. This local memory is not cached and there is no bank conflict resolution. These small local memories have a shorter latency than the main global memory interfaces.

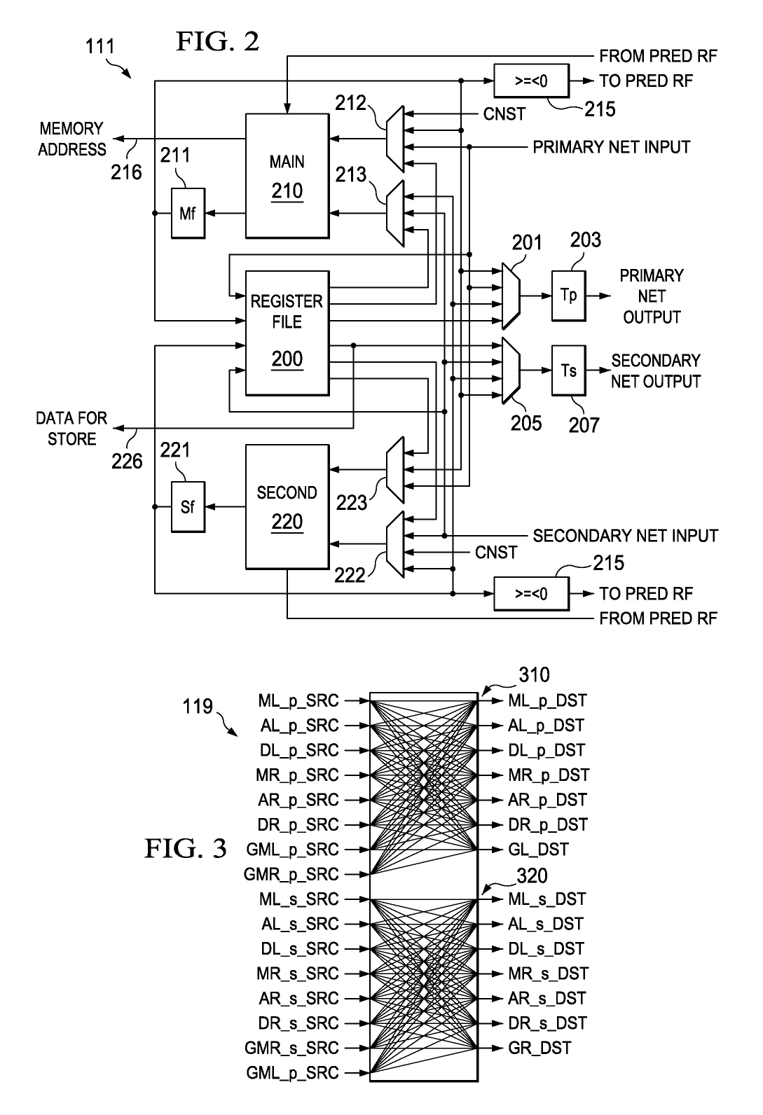

FIG. 2 illustrates a simplified block diagram of the hardware of data left sub-cluster 111 as a representative sub-cluster. FIG. 2 includes register file 200 with 6 read ports and 4 write ports, and functional units M 210 and S 220. Register file 200 in each sub-cluster includes 24 64-bit registers. These registers can also be accessed as register pairs for a total of 128-bits. The data path width of the functional units is 128 bits allowing maximum computational bandwidth using register pairs.

Main functional unit 210 includes one output to forwarding register Mf 211 and two operand inputs driven by respective multiplexers 212 and 213. Main functional unit 210 of representative sub-cluster 111 is preferably a memory address calculation unit having an additional memory address output 216. Functional unit 210 receives an input from an instruction designated predicate register to control whether the instruction results abort. The result of the computation of main functional unit 210 is always stored in forwarding register Mf 210 during the buffer operation 813 (further explained below). During the next pipeline phase forwarding register Mf 210 supplies its data to one or more of: an write port register file 200; first input multiplexer 212; comparison unit 215; primary net output multiplexer 201; secondary net output multiplexer 205; and input multiplexer 223 of secondary functional unit 220. The destination or destinations of data stored in forwarding register Mf 211 depends upon the instruction.

First input multiplexer 212 selects one of four inputs for the first operand src1 of main functional unit 210 depending on the instruction. A first input is instruction specified constant cnst. As described above in conjunction with the instruction coding illustrated in FIGS. 5 and 6, the second and third operand fields of the instruction can specify a 5-bit constant. This 5-bit instruction specified constant may be zero filled or sign filled to the 64-bit operand width. A second input is the contents of forwarding register Mf 211. A third input is data from primary net input register 214. The use of this input will be further described below. A fourth input is from an instruction specified register in register file 200 via one of the 6 read ports.

Second input multiplexer 213 selects one of three inputs for the second operand src2 of main functional unit 210 depending on the instruction. A first input is the contents of forwarding register Sf 220 connected to secondary functional unit 220. A second input is data from secondary net input register 224. The use of this input will be further described below. A third input is from an instruction specified register in register file 200 via one of the 6 read ports.

Secondary functional unit 220 includes one output to forwarding register Sf 221 and two operand inputs driven by respective multiplexers 222 and 223. Secondary functional unit 220 is similarly connected as main functional unit 210. Functional unit 220 receives an input from an instruction designated predicate register to control whether the instruction results aborts. The result of the computation of secondary functional unit 220 is always stored in forwarding register Sf 220 during the buffer operation 813. Forwarding register Sf 230 supplies its data to one or more of: a write port register file 200; first input multiplexer 222; comparison unit 225; primary net output multiplexer 201; secondary net output multiplexer 205; and input multiplexer 213 of main functional unit 210. The destination or destinations of data stored in forwarding register Sf 221 depends upon the instruction.

First input multiplexer 222 selects one of four inputs for the first operand src1 of main functional unit 210 depending on the instruction: the instruction specified constant cnst; forwarding register Sf 221; secondary net input register 214; and an instruction specified register in register file 200 via one of the 6 read ports. Second input multiplexer 213 selects one of three inputs for the second operand src2 of secondary functional unit 220 depending on the instruction: forwarding register Mf 211 of main functional unit 210; primary net input register 214; and an instruction specified register in register file 200 via one of the 6 read ports.

FIG. 2 illustrates connections between representative sub-cluster 111 and the corresponding transport switch 119. Multiplexer 212 can select data from the primary net input for the first operand of main functional unit 210. Similarly multiplexer 223 can select data from the primary net input for the second operand of secondary functional unit 220. Multiplexer 213 can select data from the secondary net input for the second operand of main functional unit 210. Similarly multiplexer 222 can select data from the secondary net input for the first operand of secondary functional unit 220.

Representative sub-cluster 111 can supply data to the primary network and the secondary network. Primary output multiplexer 201 selects the data supplied to primary transport register 203. A first input is from forwarding register Mf 211. A second input is from the primary net input. A third input is from forwarding register 221. A fourth input is from register file 200. Secondary output multiplexer 205 selects the data supplied to secondary transport register 207. A first input is from register file 200. A second input is from the secondary net input. A third input is from forwarding register 221. A fourth input is from forwarding register Mf 211.

Sub-cluster 111 can separately send or receive data primary net or secondary net data via corresponding transport switch 119. FIG. 3 schematically illustrates the operation of transport switch 119. Transport switches 129, 139 and 149 operate similarly. Transport switch 119 has no storage elements and is purely a way to move data from one sub-cluster register file to another. Transport switch 119 includes two networks, primary network 310 and secondary network 320. Each of these networks is a set of seven 8-to-1 multiplexers. This is shown schematically in FIG. 3. Each multiplexer selects only a single input for supply to its output. Scheduling constraints in the complier will enforce this limitation. Each multiplexer in primary network 310 receives inputs from the primary network outputs of: math M left functional unit; math A left functional unit; data left functional unit; math M right functional unit; math A right functional unit; data right functional unit; global register left; and global register right. The seven multiplexers of primary network 310 supply data to the primary network inputs of: math M left functional unit; math A left functional unit; data left functional unit; math M right functional unit; math A right functional unit; data right functional unit; and global register left. Each multiplexer in primary network 320 receives inputs from the secondary network outputs of: math M left functional unit; math A left functional unit; data left functional unit; math M right functional unit; math A right functional unit; data right functional unit; global register left; and global register right. The seven multiplexers of secondary network 320 supply data to the secondary network inputs of: math M left functional unit; math A left functional unit; data left functional unit; math M right functional unit; math A right functional unit; data right functional unit; and global register right. Note that only primary network 310 can communicate to the global register left and only secondary network 320 communicates with global register right.

The data movement across transport switch 119 is via special move instructions. These move instructions specify a local register destination and a distant register source. Each sub-cluster can communicate with the register file of any other sub-cluster within the same cluster. Moves between sub-clusters of differing clusters require two stages. The first stage is a write to either left global register or to right global register. The second stage is a transfer from the global register to the destination sub-cluster. The global register files are actually duplicated per cluster. As show below, only global register moves can write to the global clusters. It is the programmer's responsibility to keep data coherent between clusters if this is necessary. Table 2 shows the type of such move instructions in the preferred embodiment.

TABLE 2

| Instruction | Operation |
|---|---|
| MVD | Transfer 64-bit data register through |
| | transport switch sub-cluster to sub- |
| | cluster or global register to sub-cluster |
| MVQ | Transfer 128-bit register pair through |
| | transport switch sub-cluster to sub- |
| | cluster or global register to sub-cluster |
| MVQD | Extract 64 bits from 128-bit register |
| | pair and transfer sub-cluster to sub- |
| | cluster or global register to sub-cluster |
| MVPQ | Transfer 128 bits of the predicate register |
| | file through crossbar sub-cluster to sub-cluster |
| MVPD | Transfer 16-bit value from 1 predicate |
| | register file to a 64-bit data register |
| MVDP | Transfer 16-bit value from a 64-bit data |
| | register file to a 16-bit predicate register |
| MVP | Transfer a specific predicate register into the |
| | move network sub-cluster to sub-cluster or |
| | global register file to sub-cluster, |
| | zero extend the upper 48 bits of the register |
| GMVD | Transfer 64-bit register from a sub- |
| | cluster to the global register file |
| GMVQ | Transfer 128-bit register pair from a |
| | sub-cluster to the global register file |
| GMVQD | Extract 64-bits from 128 bit register pair and |
| | transfer sub-cluster to global register file |

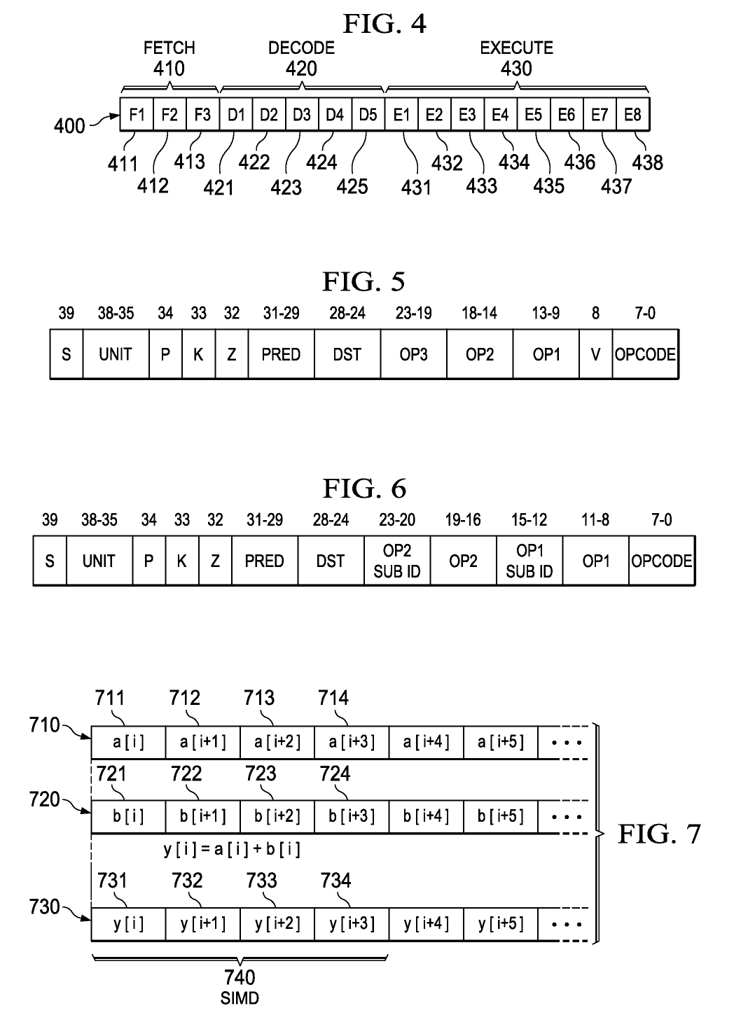

FIG. 4 illustrates the pipeline stages 400 of data processor 100. These pipeline stages are divided into three groups: fetch group 410; decode group 420; and execute group 430. All instructions in the instruction set flow through the fetch, decode, and execute stages of the pipeline. Fetch group 410 has three phases for all instructions, and decode group 420 has five phases for all instructions. Execute group 430 requires a varying number of phases depending on the type of instruction.

The fetch phases of the fetch group 410 are: program address send phase 411 (PS); bank number decode phase 412 (BN); and program fetch packet return stage 413 (PR). Data processor 100 can fetch a fetch packet (FP) of eight instructions per cycle per cluster. All eight instructions for a cluster proceed through fetch group 410 together. During PS phase 411, the program address is sent to memory. During BN phase 413, the bank number is decoded and the program memory address is applied to the selected bank. Finally during PR phase 413, the fetch packet is received at the cluster.

The decode phases of decode group 420 are: decode phase D1 421; decode phase D2 422; decode phase D3 423; decode phase D4 424; and decode phase D5 425. Decode phase D1 421 determines valid instructions in the fetch packet for that cycle by parsing the instruction P bits. Execute packets consist of one or more instructions which are coded via the P bit to execute in parallel. This will be further explained below. Decode phase D2 422 sorts the instructions by their destination functional units. Decode phase D3 423 sends the predecoded instructions to the destination functional units. Decode phase D3 423 also inserts NOPS if these is no instruction for the current cycle. Decode phases D4 424 and D5 425 decode the instruction at the functional unit prior to execute phase E1 431.

The execute phases of the execute group 430 are: execute phase E1 431; execute phase E2 432; execute phase E3 433; execute phase E4 434; execute phase E5 435; execute phase E6 436; execute phase E7 437; and execute phase E8 438. Different types of instructions require different numbers of these phases to complete. Most basic arithmetic instructions such as 8, 16 or 32 bit adds and logical or shift operations complete during execute phase E1 431. Extended precision arithmetic such as 64 bits arithmetic complete during execute phase E2 432. Basic multiply operations and finite field operations complete during execute phase E3 433. Local load and store operations complete during execute phase E4 434. Advanced multiply operations complete during execute phase E6 436. Global loads and stores complete during execute phase E7 437. Branch operations complete during execute phase E8 438.

FIG. 5 illustrates an example of the instruction coding of instructions used by data processor 100. This instruction coding is generally used for most operations except moves. Data processor 100 uses a 40-bit instruction. Each instruction controls the operation of one of the functional units. The bit fields are defined as follows.

The S bit (bit 39) designates the cluster left or right side. If S=0, then the left side is selected. This limits the functional unit to sub-clusters 111, 113, 115, 121, 123, 125, 131, 133, 135, 141, 143 and 145. If S=1, then the right side is selected. This limits the functional unit to sub-clusters 112, 114, 116, 122, 124, 126, 132, 134, 136, 142, 144 and 146.

The unit vector field (bits 38 to 35) designates the functional unit to which the instruction is directed. Table 3 shows the coding for this field.

TABLE 3

| Vector | I Slot | Functional Unit |
|---|---|---|
| 00000 | DLM | Data left main unit |
| 00001 | DLS | Data left secondary unit |
| 00010 | DLTm | Global left memory access |
| 00011 | DLTp | Data left transport primary |
| 00100 | DLTs | Data left transport secondary |
| 00101 | ALM | A math left main unit |
| 00110 | ALS | A math main left secondary unit |
| 00111 | ALTm | A math local left memory access |
| 01000 | ALTp | A math left transport primary |
| 01001 | ALTs | A math left transport secondary |
| 01010 | MLM | M math left main unit |
| 01011 | MLS | M math left secondary unit |
| 01100 | MLTm | M math local left memory access |
| 01101 | MLTp | M math left transport primary |
| 01110 | MLTs | M math left transport secondary |
| 01111 | C | Control Slot for left side |
| 10000 | DRM | Data right main unit |
| 10001 | DRS | Data right secondary unit |
| 10010 | DRTm | Global right memory access |
| 10011 | DRTp | Data right transport primary |
| 10100 | DRTs | Data right transport secondary |
| 10101 | ARM | A math right main unit |
| 10110 | ARS | A math main right secondary unit |
| 10111 | ARTm | A math local right memory access |
| 11000 | ARTp | A math right transport primary |
| 11001 | ARTs | A math right transport secondary |
| 11010 | MRM | M math right main unit |
| 11011 | MRS | M math right secondary unit |
| 11100 | MRTm | M math local right memory access |
| 11101 | MRTp | M math right transport primary |
| 11110 | MRTs | M math right transport secondary |
| 11111 | C | Control Slot for right side |

The P bit (bit 34) marks the execute packets. The p-bit determines whether the instruction executes in parallel with the following instruction. The P bits are scanned from lower to higher address. If P=1 for the current instruction, then the next instruction executes in parallel with the current instruction. If P=0 for the current instruction, then the next instruction executes in the cycle after the current instruction. All instructions executing in parallel constitute an execute packet. An execute packet can contain up to eight instructions. Each instruction in an execute packet must use a different functional unit.

The K bit (bit 33) controls whether the functional unit result is written into the destination register in the corresponding register file. If K=0, the result is not written into the destination register. This result is held only in the corresponding forwarding register. If K=1, the result is written into the destination register.

The Z field (bit 32) controls the sense of predicated operation. If Z=1, then predicated operation is normal. If Z=0, then the sense of predicated operation control is inverted.

The Pred field (bits 31 to 29) holds a predicate register number. Each instruction is conditional upon the state of the designated predicate register. Each sub-cluster has its own predication register file. Each predicate register file contains 7 registers with writable variable contents and an eight register hard coded to all 1. This eighth register can be specified to make the instruction unconditional as its state is always known. As indicated above, the sense of the predication decision is set the state of the Z bit. The 7 writable predicate registers are controlled by a set of special compare instructions. Each predicate register is 16 bits. The compare instructions compare two registers and generate a true/false indicator of an instruction specified compare operation. These compare operations include: less than, greater than; less than or equal to; greater than or equal to; and equal to. These compare operations specify a word size and granularity. These include scalar compares which operate on the whole operand data and vector compares operating on sections of 64 bits, 32 bits, 16 bits and 8 bits. The 16-bit size of the predicate registers permits storing 16 SIMD compares for 8-bit data packed in 128-bit operands. Table 4 shows example compare results and the predicate register data loaded for various combinations.

TABLE 4

| | | Stored in |
|---|---|---|
| Type | Compare Results | Predicate Register |
| 1H scalar | 0x00000000:0000FFFF | 1111111111111111 |
| 4H vector | 0x0000FFFF:0000FFFF | 0000000000110011 |
| 8H vector | 0x0000FFFF:0000FFFF: | 0001101100110011 |
| | 0000FFFF:0000FFFF | |
| 1W scalar | 0x00000000:FFFFFFFF | 1111111111111111 |
| 2W vector | 0x00000000:FFFFFFFF | 0000000000001111 |
| 4W vector | 0x00000000:FFFFFFFF: | 0000111100001111 |
| | 00000000:FFFFFFFF | |
| 1D scalar | 0xFFFFFFFF:FFFFFFFF | 1111111111111111 |
| 2D vector | 0xFFFFFFFF:FFFFFFFF: | 1111111100000000 |
| | 00000000:00000000 | |
| 8B vector | 0x00FF00FF:00FF00FF | 0000000001010101 |
| 16B vector | 0x00FF00FF:00FF00FF: | 0101010101010101 |
| | 00FF00FF:00FF00FF | |

The DST field (bits 28 to 24) specifies one of the 24 registers in the corresponding register file or a control register as the destination of the instruction results.

The OPT3 field (bits 23 to 19) specifies one of the 24 registers in the corresponding register file or a 5-bit constant as the third source operand.

The OPT2 field (bits 18 to 14) specifies one of the 24 registers in the corresponding register file or a 5-bit constant as the second source operand.

The OPT1 field (bits 13 to 9) specifies one of the 24 registers of the corresponding register file or a control register as the first operand.

The V bit (bit 8) indicates whether the instruction is a vector (SIMD) predicated instruction. This will be further explained below.

The opcode field (bits 7 to 0) specifies the type of instruction and designates appropriate instruction options. A detailed explanation of this field is beyond the scope of this invention except for the instruction options detailed below.

FIG. 6 illustrates a second instruction coding generally used for data move operations. These move operations permit data movement between sub-clusters with a cluster and also between sub-clusters of differing clusters. This second instruction type is the same as the first instruction type illustrated in FIG. 5 except for the operand specifications. The three 5-bit operand fields and the V bit are re-arranged into four 4-bit operand fields. The OP2 sub-cluster ID field (bits 23 to 20) specifies the identity of another cluster as the source of a second operand. The OP2 field (bits 19 to 16) specifies a register number for the second operand. The OP1 sub-cluster ID field (bits 15 to 12) specifies the identity of another cluster as the source of a first operand. The OP1 field (bits 11 to 8) specifies a register number for the first operand. All other fields are coded identically to corresponding fields described in conjunction with FIG. 5.

Register file bypass or register forwarding is a technique to increase the speed of a processor by balancing the ratio of clock period spent reading and writing the register file while increasing the time available for performing the function in each clock cycle. This invention will be described in conjunction with the background art.

Sub-word parallel instructions (often called SIMD instructions) implement vector computation for short vectors packed into data words. Vector computers that feature vector instructions operate on vector register files. These SIMD instructions split the scalar machine data word into smaller slices/sub-words and operate on the slices independently. This generally involves breaking the carry chain at the element boundaries. This provides low cost vector style operations on arrays if the array elements are short enough to be packed into a machine word. Iterating over the data with such SIMD instructions can yield high performance.

SIMD instructions are often a good fit to a variety of algorithms in media and signal processing. SIMD instruction extensions have been added to most general purpose microprocessor instruction sets, for example MMX, 3DNOW, SSE, VMX, Altivec and VIS. Digital signal processors (DSPs) such as the Texas Instruments C6400 family utilize SIMD instructions to exploit data parallelism when operating on short width data arrays.

Consider the the loop:

for(i=0;i<n;i++) {

y[i] = a[i] + b[i];

}

If the a and b arrays hold values that do not exceed one quarter of the machine width (for example 8-bit values on a 32-bit machine), this loop can be speeded up with a 4-way SIMD add instruction add4 as follows:

for(i=0;i<n;i+=4) {

y[i:i+3] = _add4(a[i:i+3], b[i:i+3]);

}

This is illustrated in FIG. 7. Vector elements 711, 712, 713 and 714 of first operand 710 are added to respective vector elements 721, 722, 723 and 724 of second operand 720. The result is corresponding vector elements 731, 732, 733 and 734 of result 730.

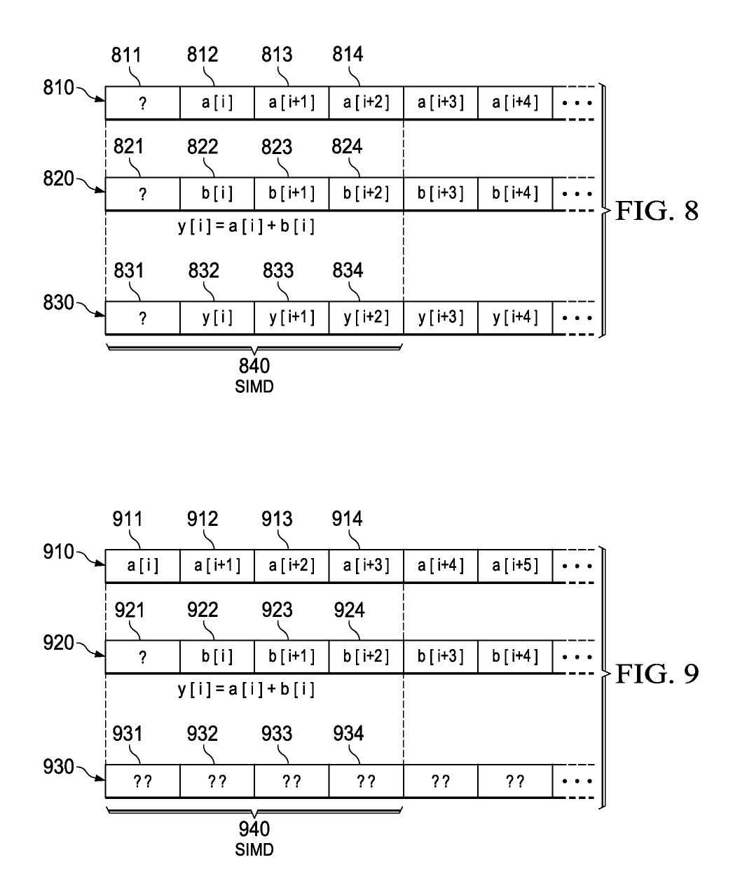

There are a some restrictions for this to work. The starting address for the arrays should be aligned to the data word width, in this example 32 bits. FIG. 8 illustrates the problem. Vector elements 811 of operand 810 and 821 of operand 820 are undefined and produce an undefined resultant vector 831 in result 830 Thus SIMD operation 840 produces an anomalous result because the vectors a[i] and b[i] are not aligned to word boundaries. FIG. 9 illustrates another problem. This SIMD instruction operation works correctly only if the vector elements a[i] and b[i] are similarly aligned within data words. In FIG. 9 vector element 911 of operand 910 should be aligned with vector element 922 of operand 920. Because they are not so aligned the result 930 of SIMD operation 940 is incorrect for all vector elements 931, 932, 933 and 934. Another problem concerns the number of elements in the two input vectors. The number of elements in the vectors n should be divisible by the SIMD width. The SIMD width in this example is 4, therefore n should be a integral factor of 4. If n is not an integral factor of 4, then at least one non-aligned SIMD operation such as illustrated in FIG. 8 will occur. Further, if the addition were conditional for some elements the add4 instruction cannot be used. This is would happen if the original loop was:

for (i=0;i<n;i++) {

If ((i mod 8)>=3 && i!=17) {

y[i] = a[i] + b[i];

}

}

Some of these problems can be handled by re-organizing the data being processed. This re-organization would use either memory buffers or registers and scatter-gather load-store instructions. Alignment of the arrays to the data processor word width can be handled using non-aligned gather load instructions, if available, to load non-aligned data into a memory buffer or data registers. This would reorganize the data stream in the registers. The data may be written back to an output array in memory using scatter store instructions. In the absence of such instructions, the alignment can be performed with a copy loop before the actual processing loop. This technique is useful only with a sufficiently large the loop count.

Similarly, the divisibility constraint can be handled by doing the last (or first) n mod 4 iterations in a separate loop that doesn't use the vector instructions. This limits the divisibility problem to end cases. There is a minimum iteration count that makes this transformation feasible. For short loops this may reduce performance.

The typical way to handle conditionals in the loop body, makes packed copies or subsets of the data that correspond to each condition value. Then these are separately processed using unconditional SIMD instructions. The appropriate computed vector elements are then selected based upon the conditional values.

Each of these techniques spend memory and/or cycles to prepare the data for processing with SIMD instructions. This requires larger buffer and/or causes performance loss. These methods also limit the applicability of the SIMD instructions to loops with large iteration counts needed to amortize of the cycles and memory spent to prepare the data. In addition, none of these techniques adequately handles conditional execution on the vector element level.

Predication is a well understood method for expressing condition execution. Predicate registers of the processor are used to store the results of a condition evaluation. These predicate registers may be dedicated registers or registers from the pool of general purpose registers. The execution of a subsequent instruction is conditional on the value stored in a corresponding predicate register. The value of the predicate may be stored in a register that is 1 bit wide or as wide as the machine width. However, each predicate register logically stores only one bit worth of information used for the following conditional execution. These are called scalar predicates. Scalar predicates can be used to conditionally execute scalar operations or vector and SIMD operations. However, for SIMD operations, these cannot provide fine grain control over the execution of each slice or data element of the SIMD operation. The granularity of the scalar predicate is that of the smallest machine word operated on by scalar instructions. Thus either all the sub-words of the SIMD execution are executed or none. As a result, predication with scalar predicates do not help with the SIMD instruction loop problems mentioned above except for simple conditions.

This invention uses vector predicates to solve these problems more efficiently than current methods. The primary mechanism of this invention is a set of registers that store vectors of scalar predicates. The width of these vector predicate registers is equal to the width of the widest SIMD operation in the machine. Thus if the widest SIMD operation is a 8 way SIMD add, the vector predicate registers are 8 bits wide. Each bit of a vector predicate is used to guard the corresponding slice of the SIMD operation. For a 8 way SIMD an instruction in a 64-bit machine:
[vp0] ADD8H L0, L1, L3
each 8 bit slice of L0 is added to the corresponding 8 bit slice in L1 and stored in the same position in L3 if the corresponding bit position in the vector register vp0 is set. This means that L3[7:0]≦L2[7:0]+L3[7:0] if vp0[0]=1. The same applies for the other 8-bit slices of the registers L0, L1 and L3. This guarded mode of operation for sub-words allows the programmer to mask the effects of an operation selectively for sub-words.

Vector predicates permit solutions to the problems of non-divisible array lengths. For the end conditions at the beginning or end of the array a vector predicate can selectively mask out the sub-words that fall outside the arrays. This can be used at both ends thus not requiring the start or the end of the vectors to be aligned to word boundaries.

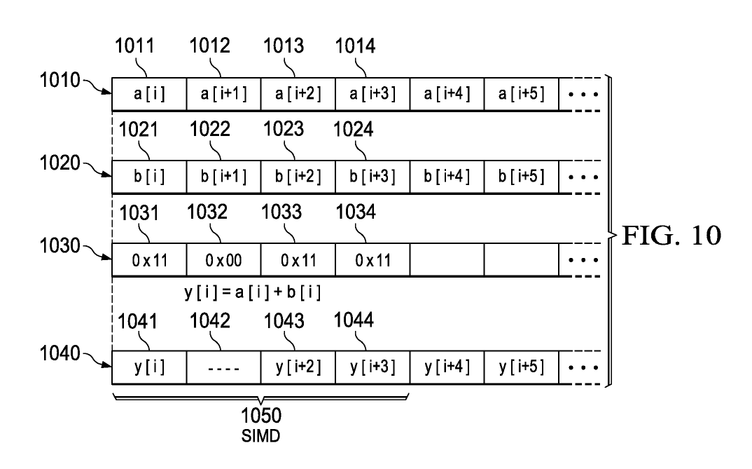

Conditionals within the loop are handled as follows. The vector predicates are set with a SIMD condition evaluation. This produces conditional bits corresponding to the elements of the short vector that need to be processed in that iteration. FIG. 10 illustrates and example vector predicated SIMD instruction. Vector predicate 1030 has three vector elements 1031, 1033 and 1034 filled with 1's. For these vectors the resultant y[i] in result 1040 is computed normally. Vector predicate 1030 has vector element 1032 filled with 0's. For this vector element the result vector element 1042 is unchanged from the original contents of the destination register, here designated as “ - - - ”. Thus vector predicate instructions operate like scalar predicate instructions for each vector element.

For arrays misaligned in memory, vector predicates can be augmented with a permute instruction. Given a permute, a vector predicate can be used to mask off the elements of the array for the load instruction and the loaded elements packed for use with a SIMD instruction.

This invention uses SIMD compare operations to set bits within an instruction specified predicate register. The number bits in each predicate register equals the maximum number of vector elements that can be separately handled by a SIMD instruction. In the preferred embodiment 16 8-bit vector elements can be separately handled in a 128-bit register pair instruction. The lower 8 bits of each vector predicate register are used for single register 64-bit word instructions. The whole 16 bits of each vector predicate register are used for paired register 128-bit double word instructions. Single register 64-bit compare instructions set only the 8 least significant bits. Paired register 128-bit double word compare instructions set all 16 bits.

The pattern of bits set is determined by the number of elements in the compare instruction. A single way 64-bit word compare instruction sets all 8 least significant bits in the same state based upon a 64-bit word compare. Two way, 4 way and 8 way compares set the predicate bits as shown in Table 5.

TABLE 5

| Ways | Operand bits/Predicate Register bits | | | | | | | |
|---|---|---|---|---|---|---|---|---|
| 1 way | 0-63 | | | | | | | |
| | 0-7 | | | | | | | |
| 2 way | 0-31 | | | | 32-62 | | | |
| | 0-3 | | | | 4-7 | | | |
| 4 way | 0-15 | | 16-31 | | 32-47 | | 48-63 | |
| | 0-1 | | 2-3 | | 4-5 | | 6-7 | |
| 8 way | 0-7 | 8-15 | 15-23 | 24-31 | 32-39 | 40-47 | 48-55 | 56-63 |
| | 0 | 1 | 2 | 3 | 4 | 5 | 6 | 7 |

The 8 most significant bits of each predicate register are similarly set according to the number of ways by register pair 128-bit compare instructions.

The predicate register bits are similarly applied to SIMD instruction operation dependent upon the number of vector elements in the SIMD instruction. Note that the element size in the compare instruction setting the predicate bits does not have to the same as the use SIMD instruction. However, all the predicate register bits corresponding to one element of the operands must be the same during the vector predicate instruction. Thus generally the compares instruction setting the predicate bits must have no fewer sections than the use vector predicate instruction.

Replicating the compare bit across every section as shown in Table 5 allows a scalar to control a vector instruction or a vector to control a finer grained vector instruction. However, for SIMD operations these cases cannot provide fine grain control over the execution of each slice of the SIMD operation.

What is claimed is:

1. A data processing apparatus comprising:
a data register file including a plurality of data registers storing data;
a functional unit having a first data input, a second data input and a data output, said functional unit operable to perform an instruction specified data operation upon data received from a first instruction specified operand data register received at said first data input and data from a second instruction specified operand data register received at said second data input and generating result data at said data output to write into an instruction specified destination data register, said functional unit selectively dividable into a plurality of equal sized sections, each section generating at a corresponding output section a result representing a combination of respective sections of said first and second input data; and
a predicate register file including at least on predicate register having a number of bits equal to said number of sections; and
wherein said functional unit is further operable to
perform said instruction specified data operation upon sections of data and generating a corresponding section of result data for sections where a corresponding bit of said predicate register has a first digital state, and
not perform said instruction specified data operation upon sections of data for sections where a corresponding bit of said predicate register has a second digital state opposite to said first digital state.

2. The data processor of claim 1, wherein:
said functional unit is further operable to not write data into said destination register for sections where said corresponding bit of said predicate register has said second digital state whereby data for said sections of said destination register stored in said register file are unchanged.

3. The data processor of claim 1, wherein:
said predicate register file includes a plurality of predicate registers; and
said functional unit is further operable to perform or not perform said instruction specified data operation upon sections of data for sections dependent upon said digital state of a corresponding bit of an instruction specified one of said plurality of predicate registers.

4. The data processor of claim 1, wherein:
said functional unit is operable in response to a compare instruction to selectively divide into said sections, generate an instruction selected comparison result in a first digital state or a second digital state for each section dependent upon respective sections of said first and second input data, and store said compare results for all sections in said predicate register.

5. The data processing apparatus of claim 4, wherein:
said instruction specified comparison is whether said section of said first data input is less than said corresponding said second data input.

6. The data processing apparatus of claim 4, wherein:
said instruction specified comparison is whether said section of said first input data is less than or equal to said corresponding section of said second input data.

7. The data processing apparatus of claim 4, wherein:
said instruction specified comparison is whether said section of said first input data is equal to said corresponding section of said second input data.

8. The data processing apparatus of claim 4, wherein:
said instruction specified comparison is whether said section of said first input data is greater than said corresponding section of said second input data.

9. The data processing apparatus of claim 4, wherein:
said instruction specified comparison is whether said section of said first input data is greater than or equal to said corresponding section of said second input data.

10. The data processing apparatus of claim 4, wherein:
said functional unit is selectively dividable into sections having a number of sections determined by instruction type.
